(19) United States
(12) Patent Application Publication
(10) Pub. No.: US 2011/0187620 A1
(43) Pub. Date: Aug. 4, 2011

(54) Aerial

(75) Inventors: Walter Barbirato, S. Giuseppe di Cassola (IT); Luigino Righetto, Quinto di Treviso (IT)

(73) Assignee: FRACARRO RADIOINDUSTRIE S.P.A., Castelfranco Veneto (TV) (IT)

(21) Appl. No.: 12/994,084

(22) PCT Filed: Jun. 9, 2009
(86) PCT No.: PCT/IB2009/005885

§ 371 Date: Mar. 3, 2011

(30) Foreign Application Priority Data
Jun. 17, 2008 (IT) TO2008A000473

(51) Int. Cl. H01Q 19/30

(52) U.S. Cl. 343/773

(57) ABSTRACT

The invention relates to an aerial (1) for receiving and transmitting radio signals within a certain frequency band. The aerial (1) comprises a radiator element (3) which can radiate a linearly polarized radio signal within the operating band of the aerial. The latter also comprises a support element (2) and at least one first director element (4) mounted on said support element. The director element comprises a body which is conductive within the operating band of the aerial. The shape of said body is such that the projection thereof onto a plane orthogonal to the direction of maximum gain of the aerial encloses a limited plane portion.

The present invention relates to an aerial according to the preamble of claim 1.

Nowadays several types of aerials are known, which can be classified according to a number of features such as the capability of receiving linear of circular polarizations.

In general, an aerial comprises three basic elements: a radiator which generates the electromagnetic field (i.e. the radio signal) transmitted by the aerial, a reflector, and one or more directors which modify such field in order to make the aerial more directive.

Yagi-Uda aerials allow for the reception and transmission of linearly polarized electromagnetic fields; these aerials are equipped with a radiator adapted to generate such a field (e.g. a λ/2 dipole or a bent dipole) and with linearly shaped directors (typically metal rods) adapted to receive a linear polarization, i.e. a linearly polarized electric field.

Aerials of this kind are known from patent application GB 2406971, which describes aerials whose directors are metal rods laid on the aerial boom, or X-shaped elements with metal rods inserted in a dielectric housing and coming out thereof in a criss-cross pattern.

Instead, Yagi loop aerials can receive a radio wave having elliptic or circular polarization and are characterized by annular radiator and directors having a circular cross-section.

The number of directors, the power supplied to the radiator, and the length of the aerial being equal, this second type of aerial is usually more directive and provides a wider bandwidth than Yagi-Uda aerials.

However, Yagi loop aerials suffer from the drawback that it is not possible to discriminate between horizontal-polarization and vertical-polarization radio signals.

It is the object of the present invention to provide an aerial which is alternative to the prior art.

In particular, the main object of the present invention is to improve the directivity and gain of known aerials for receiving linearly polarized signals.

These objects are achieved through an aerial incorporating the features set out in the appended claims, which are intended as an integral part of the present description.

The present invention is based on the idea of using a radiator which can generate and receive a linearly polarized electromagnetic field (i.e. radio signal) and of using directors adapted to receive an electromagnetic field having elliptic or circular polarization.

The directors have a body which is conductive within the operating frequency of the aerial; aiming at receiving circular polarization, said conductive body is such that the projection thereof onto a plane orthogonal to the direction of maximum gain of the aerial encloses a limited portion of said plane.

For example, said projection may be a ring (having a circular or elliptic shape) or more in general a figure which closes back to itself at least in one point, like a noose.

Tests carried out by the Applicant have shown, in fact, that directors of this type increase the gain of the aerial even if the radiator is used for generating or receiving a linearly polarized electromagnetic field.

Advantageously, the director element of the aerial may comprise a helicoidal element with an axis of rotation of the helix that is parallel to or coinciding with the direction of maximum gain of the aerial. This solution offers the advantage that the aerial assembly process is simplified and the aerial is mechanically stronger.

Further objects and advantages of the present invention will become apparent from the following description and from the annexed drawings, which are supplied by way of non-limiting example, wherein:

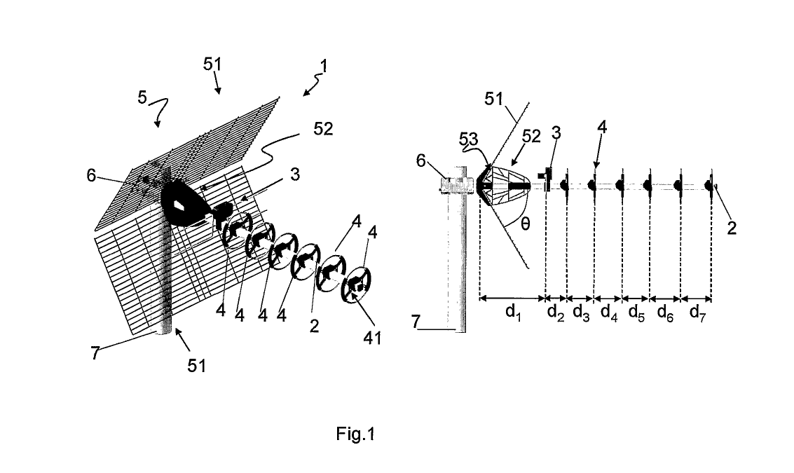

FIG. 1 shows two perspective views of an aerial according to a first embodiment of the present invention;

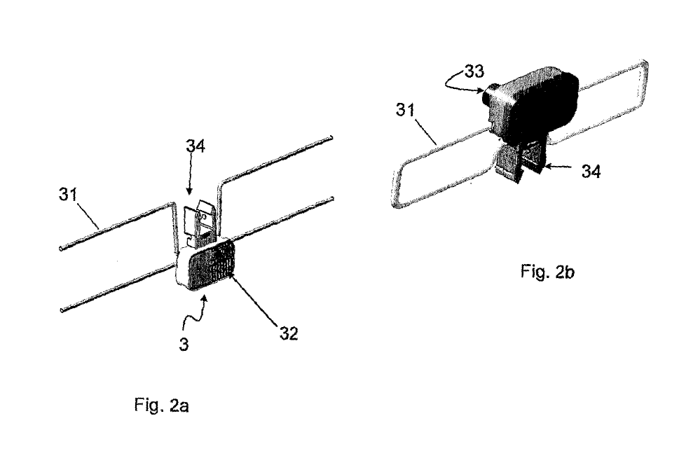

FIGS. 2a and 2b show two examples of radiators which may be used in the aerial of FIG. 1;

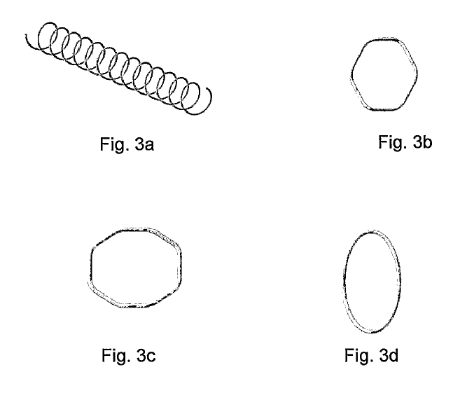

FIGS. 3a-3d show some possible shapes of a director element of an aerial according to the present invention;

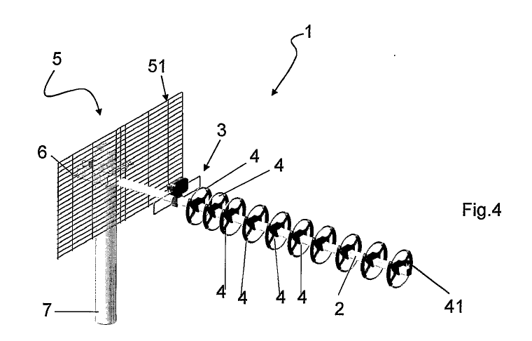

FIG. 4 shows an aerial according to a second embodiment of the present invention;

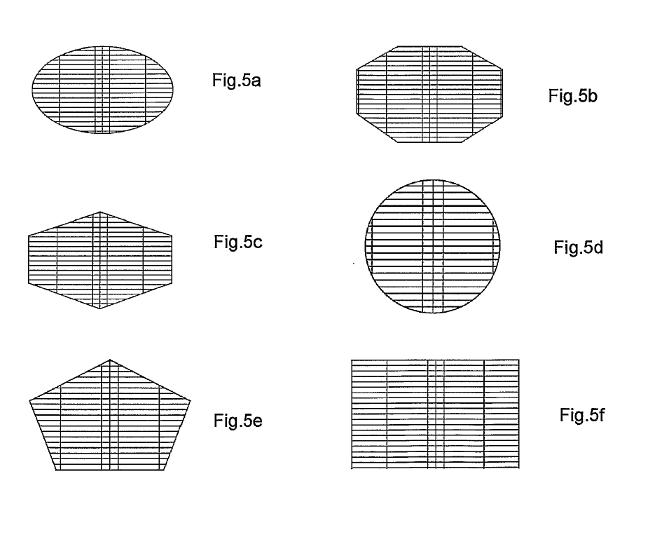

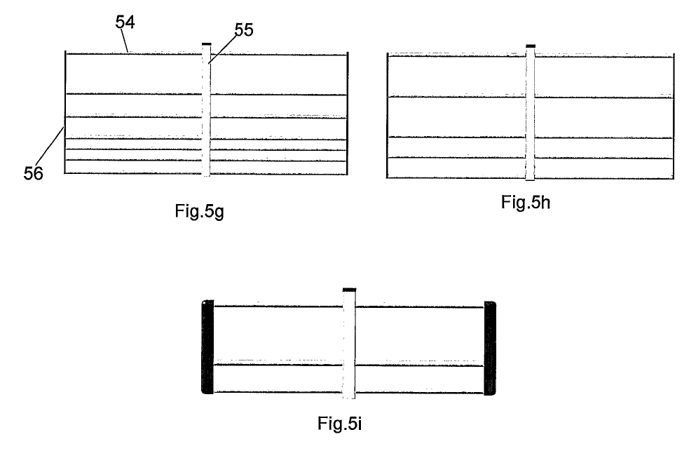

FIGS. 5a-5i show some possible shapes of a reflector grid of an aerial according to the present invention;

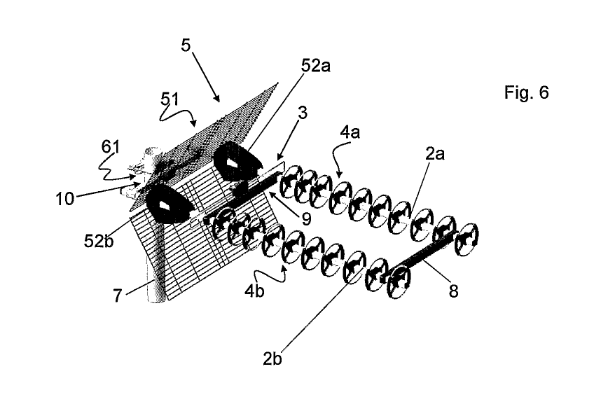

FIG. 6 shows an aerial according to a third embodiment of the present invention;

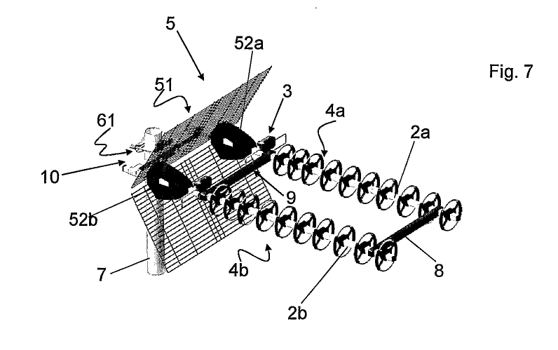

FIG. 7 shows an array of aerials comprising two aerials according to the present invention;

FIG. 1 shows an aerial 1 according to a first embodiment of the present invention.

Aerial 1 is designed to receive and transmit linearly polarized radio signals within the UHF band.

Aerial 1 comprises a support element 2, which in the example of FIG. 1 is a rod (referred to as “boom” in the industry), on which a radiator 3, directors 4 and a reflector 5 are mounted. Aerial 1 is also provided with a fitting 6 through which it can be mounted onto a pole 7.

In the example of FIG. 1, radiator 3, shown in FIG. 2a, is a biconic dipole and can generate and receive linearly polarized radio signals.

Radiators of the type shown in FIG. 2a are, for example, those mounted on the BLU420F aerials sold by Fracarro Radioindustrie S.p.A, and comprise a conductor 31, typically a metal rod or plate, which is bent in a manner such as to form a two-whisker structure resembling a biconic structure.

Radiator 3 is also fitted with a balun placed inside housing 32, which allows the impedance of radiator 3 to be adapted to that of the coaxial cable to which the aerial will be connected, e.g. through a connector F designated by reference numeral 33.

By means of the balun, the aerial receives an alternating voltage signal which is then transferred to conductor 31, where a time-variable charge distribution is created so as to generate a linearly polarized electromagnetic field, i.e. the radio signal to be transmitted.

Conversely, when the aerial is used in reception the received electromagnetic field produces in conductor 31a time-variable charge distribution, i.e. a current that is then transferred to the coaxial cable through the balun.

Radiator 3 is also equipped with a fitting 34 for its connection to aerial boom 2.

The selection of the radiator is not binding, so long as the radiator is adapted to generate and receive linear polarizations; therefore, other types of radiators may be used as well, such as the one shown in FIG. 2b. FIG. 2b shows a bent radiator wherein conductor 31 is a rod bent in such a way as to form a “butterfly” profile. Radiators of this kind are, for example, mounted on the TAU15/45 aerials sold by Fracarro Radioindustrie S.p.A.

Although aerial 1 is designed to receive and transmit linearly polarized radio signals, directors 4 can also receive radio signals with electromagnetic fields having circular or elliptic polarization (in addition to linearly polarized signals).

As known, in the case of fields having circular or elliptic polarization the electric field can be broken up into two offset orthogonal (horizontal and vertical) vectorial components, so that the direction of the resulting field changes over time.

Each director element 4 capable of receiving fields having circular or elliptic polarization can therefore receive both components of the resulting electric field at any time instant.

In the example of FIG. 1, the aerial comprises six directors 4, each consisting of a circular metal ring.

Each director 4 is secured to boom 2 by means of a dielectric anchoring element 41, which in the example of FIG. 1 keeps boom 2 within the area defined by the perimeter of director 4.

Alternatively, director 4 may be mounted in a manner such that the boom remains outside the area defined by the perimeter of director 4.

In general, directors 4 are mounted in a manner such that the geometrical centres thereof are aligned along an axis matching the direction of maximum gain of the aerial.

Anchoring element 41 preferably comprises a clamp which allows it to be mounted easily onto the boom and which can subsequently be tightened, e.g. by means of a screw.

As known, the position of directors 4 on boom 2 depends on the gain and return loss values which are to be obtained from aerial 1, whereas the dimensions of the directors are strongly related to the frequency band to be received by aerial 1.

For an aerial which is to receive UHF band signals (470 MHz-862 MHz), the directors may advantageously consist of circular rings having a diameter of approximately 10 cm arranged at a distance of about 10 cm from one another, with the radiator located at about 20 cm from the reflector and about 5 cm from the nearest director.

In the example of FIG. 1, the aerial is designed to receive UHF band signals; the arrangement of the elements along the boom has been optimized as follows:
radiator 3 is located at a distance d₁ of 20 cm from the point where reflector 5 (dihedral type) is mounted on boom 2,
the first director is located at a distance d₂ of 5 cm from the radiator,
the second director is located at a distance d₃ of 11 cm from the first director,
the third director is located at a distance d₄ of 8 cm from the second director,
the fourth director is located at a distance d₅ of 9 cm from the third director,
the fifth director is located at a distance d₆ of 9 cm from the fourth director,
the sixth director is located at a distance d₇ of 9 cm from the fifth director.

By using directors having a diameter of 10 cm, the aerial thus optimized has a maximum gain direction that matches the longitudinal axis of the boom; in the UHF band of interest it has a gain between 12 dBi (at 470 MHz) and 15 dBi (at 862 MHz) and a return loss below −14 dB over the whole band.

Although in the example of FIG. 1 the directors consist of circular metal rings, this shape is not to be considered as limiting; in fact, different shapes are possible as well, as shown by way of example in FIGS. 3a-3d.

In all cases, in order to receive circular polarization signals within a given frequency band, the director comprises at least one body which is conductive within that band, and is shaped in a manner such that the projection of said body onto a plane orthogonal to the direction of maximum gain of the radiator encloses a limited portion of said plane.

Director 4 may thus have a helicoidal shape, as shown in FIG. 3a, and be preferably mounted on the boom in a manner such that the helix axis is parallel to or coinciding with the direction of maximum gain of the aerial.

A ring is therefore obtained when the helix thus mounted is projected onto a plane orthogonal to the direction of maximum gain, i.e. a figure that encloses a plane portion.

Should the helix have an inclined axis not orthogonal to the axis of maximum gain, the projection of the helix onto the plane orthogonal to the one of maximum gain would be a curve comprising a series of nooses connected to one another, each noose being a figure that encloses a limited plane portion.

As an alternative, director 4 may have a polygonal shape, e.g. hexagonal (FIG. 3b) or octagonal (FIG. 3c).

Also, in another embodiment director 4 may have an elliptic shape (FIG. 3d).

Preferably the director corners (if present, e.g. FIGS. 3b and 3c) are rounded off.

Director 4 preferably consists of a one-piece metal body, e.g. a sheet-metal cylinder or a metal rod.

Alternatively, director 4 may consist of a plurality of metal elements welded together or joined by means of (for example, metal clamps).

Director 4 may also alternatively include an insulating core (e.g. made of plastic) having a metal covering (e.g. an aluminum foil).

The conductive body may also comprise a capacitor, e.g. a flat-faced capacitor, which is a closed circuit within the frequency band in which the aerial operates. In this manner, the body is conductive in the frequency band of interest even if a portion thereof comprises a dielectric material.

If director 4 is a closed ring, as shown in FIGS. 3b-3d, then it is preferably mounted in a manner such as to lie in a plane orthogonal to the direction of maximum gain of the aerial.

Furthermore, the directors mounted on the same boom are preferably arranged in a manner such that the geometrical centres thereof are aligned along an axis which is parallel to the direction of maximum gain of the aerial, thus enhancing the aerial gain.

Aerial reflector 5 may be either dihedral (as shown in FIG. 1) or flat.

In the example of FIG. 1, reflector 5 is a structure consisting of two metal grids 51 arranged on opposite sides of the boom so as to correspond to the faces of a dihedral angle. The grids are mounted on a support structure 52 featuring suitable slots 53 into which they are inserted. When mounted on structure 52, grids 51 form an angle θ of 60° with the horizontal plane, i.e. with the direction of maximum gain of radiator 3 of FIG. 1.

An example of an aerial having a square flat reflector is shown in FIG. 4, wherein the same reference numerals of FIG. 1 designate identical or equivalent items.

The aerial of FIG. 4 has a bent dipole radiator 3 (FIG. 2b) employed as a substitute for the biconic dipole radiator of FIG. 1, and a flat reflector consisting of a single grid 51 mounted vertically, i.e. perpendicularly to the direction of maximum gain of the radiator.

Alternatively, a flat reflector may be obtained by means of two or more grids arranged on opposite sides of the boom and lying in one plane which is orthogonal thereto.

FIGS. 5a-5f show some possible embodiments of a grid 51 of a (flat or dihedral) reflector that may be used in the aerial according to the present invention; more in detail:
In FIG. 5a, grid 51 has an elliptic shape
In FIG. 5b, grid 51 has an octagonal shape
In FIG. 5c, grid 51 has a hexagonal shape
In FIG. 5d, grid 51 has a circular shape
In FIG. 5e, grid 51 has a pentagonal shape
In FIG. 5f, grid 51 has a rectangular shape

Whether flat or dihedral, the reflector may be provided as a grid entirely consisting of metal elements arranged in a criss-cross pattern (as shown in FIGS. 5a-5f), or it may also comprise dielectric elements.

In the examples of FIGS. 5g-5i (the so-called “tube” solution), grid 51 is made up of a plurality of (solid or hollow) metal rods 54 mounted parallel to one another on a structure comprising a metallic central upright 55 and two side uprights 56 made of metallic or dielectric material.

The number, dimensions and spacing of the rods may be varied in order to improve the directionality and gain of the aerial; in the example of FIG. 5g the reflector grid comprises seven rods; in FIG. 5h there are five rods; in FIG. 5i there are three rods.

In the examples of FIGS. 5g-5i, the grid is denser (i.e. the rods are closer together) in that portion (the lower portion in these drawings) which will be closer to the boom in the installed position; this provides the effect of improving the forward/backward ratio of the aerial.

While in FIGS. 5g and 5h side uprights 56 consist of metal plates, in FIG. 5i side uprights 56 are provided in the form of a dielectric housing in which rods 53 are secured.

The advantages of the present invention are apparent from the above description, it is therefore clear that many changes may be made thereto by those skilled in the art without departing from the protection scope of the present invention.

For example, an aerial may comprise a plurality of directors having different shapes (e.g. a helix and circular rings) mounted on one or more support elements.

The directors mounted on the same rod, even when having different shapes, are preferably aligned in a manner such that the respective centres are aligned along an axis which coincides with or is parallel to the direction of maximum gain of the aerial.

Also, the radiator may be any device capable of generating and receiving a linearly polarized electromagnetic field, for example, it may comprise a pair of conductors arranged symmetrically in a V pattern (this solution is known as double-V or fan aerial), so as to obtain two half-wave dipoles.

Moreover, radiator 3 may not be mounted directly on the boom. This is the case, for example, of the aerial shown in FIG. 6, wherein a single radiator 3 is placed between two booms 2a and 2b, each fitted with respective directors 4a and 4b, the number of which is ten per boom in the example of FIG. 6.

Radiator 3 of FIG. 6 is mounted in a manner such that the direction of maximum gain is a straight line parallel to both booms 2a and 2b.

The aerial of FIG. 6 comprises a single reflector 5 sized appropriately to cover radiator 3 as well as both booms 2a and 2b; reflector 5 is of the dihedral type, wherein the two grids 51 are mounted on two support structures 52a and 52b provided on both booms 2a and 2b.

For the booms to stay in position while at the same time supporting radiator 3, the aerial of FIG. 6 comprises three dielectric crosspieces 8, 9 and 10 which keep booms 2a and 2b parallel to each other.

Crosspiece 9 supports radiator 3, crosspiece 10 connects the booms to pole 7 through a fitting 61, and crosspiece 8 stiffens the overall structure of the aerial by preventing any relative movement between the two booms 2a and 2b, e.g. caused by the wind.

It is furthermore apparent that the above-described invention is also applicable to an array of aerials, meaning by that a set of aerials having a common reflector.

An example of an array of aerials is shown in FIG. 7, wherein the array comprises two aerials, each provided with its own radiator 3a and 3b and director 4a and 4b mounted on two respective booms 2a and 2b.

The array of FIG. 7 uses a single reflector 5 which is common to both aerials.

1. Aerial for receiving and transmitting radio signals within a frequency band, comprising a radiator element adapted to radiate a linearly polarized radio signal within said frequency band, a support element, and at least one first director element mounted on said support element and comprising a body which is conductive within said frequency band, wherein the projection of said body onto a plane orthogonal to the direction of maximum gain of the aerial encloses a limited portion of said plane and in that said radiator element is a biconic dipole.

2. Aerial according to claim 1 or claim 8, wherein said conductive body has a helicoidal shape and extends in a direction which is parallel to said direction of maximum gain.

3. Aerial according to claim 1 or claim 8, wherein said conductive body is a ring.

4. Aerial according to claim 3, wherein said ring has an elliptical shape.

5. Aerial according to claim 3, wherein said ring has a circular shape.

6. Aerial according to claim 1 or claim 8, wherein said conductive body is made of metal.

7. Aerial according to claim 1 or claim 8, wherein said body comprises an insulating core having a metal covering.

8. Aerial according to claim 1, wherein said body comprises a capacitor which is a closed circuit within said frequency band.

9. Aerial according to claim 1 or claim 8, comprising a plurality of director elements, wherein the geometrical centres of the conductive bodies of said director elements are aligned along said direction of maximum gain of the aerial.

10. Aerial according to claim 9, wherein a second director element has a shape which is different from that of said first director element.

11. Aerial according to claim 9, wherein said at least one director element comprises six director elements, and wherein said aerial further comprises at least one metal grid mounted on said support element, and wherein:
said radiator is located at a distance of 20 cm from the point where said grid is mounted on said support element,
the first director is located at a distance of 5 cm from the radiator,
the second director is located at a distance of 11 cm from the first director,
the third director is located at a distance of 8 cm from the second director,
the fourth director is located at a distance of 9 cm from the third director,
the fifth director is located at a distance of 9 cm from the fourth director, and
the sixth director is located at a distance of 9 cm from the fifth director.

12. Aerial according to claim 11, wherein said at least one director element has a conductive body provided in the form of a circular ring having a diameter of 10 cm.

13. Aerial according to claim 1 or claim 8, comprising at least one second support element and at least one second director element mounted on said second support element, wherein the radiator element is arranged between the two support elements of the aerial.

14. Aerial according to claim 1 or claim 8, comprising at least one second support element, one second radiator adapted to radiate a linearly polarized radio signal within said frequency band, and at least one second director element, wherein said second radiator element and said second director element are mounted on said second support element.

15. Aerial according to claim 1 or claim 8, wherein said at least one director element is adapted to receive the electric field of an electromagnetic wave having circular or elliptic polarization at any time instant.
